(19) United States
(12) Patent Application Publication
(10) Pub. No.: US 2014/0099879 A1
(43) Pub. Date: Apr. 10, 2014

(54) Hybrid Satellite and Internet Mobile Broadcast System

(71) Applicants: David Andrew Birks, New Egypt, NJ (US); Bridget S. Neville, Oaden, CT (US); Craig P. Wadin, Deafield Beach, FL (US)

(72) Inventors: David Andrew Birks, New Egypt, NJ (US); Bridget S. Neville, Oaden, CT (US); Craig P. Wadin, Deafield Beach, FL (US)

(73) Assignee: Sirius XM Radio, Inc., New York, NY (US)

(21) Appl. No.: 13/645,236

(22) Filed: Oct. 4, 2012

(51) Int. Cl. H04H 40/90

(52) U.S. Cl. CPC H04H 40/90
USPC 455/3.06

(57) ABSTRACT

Satellite audio and video broadcasting systems for concurrent, near-simultaneous broadcast to mobile and fixed receivers of satellite broadcast audio information and of internet streaming of at least the same audio information, and of video and data information, too.

### FIELD OF THE INVENTION

Satellite audio and video broadcasting systems for concurrent, near-simultaneous broadcast to mobile and fixed receivers of satellite broadcast audio information and of internet streaming of at least the same audio information, and of video and data information, too. The streamed internet information provides an ancillary terrestrial component that supplements the satellite broadcast information, and that provides a return channel from receivers in areas where wireless internet services are available.

### BACKGROUND OF THE INVENTION

Sirius XM Radio Inc. operates a Satellite Digital Audio Radio System (SDARS) to broadcast audio, video, and data content to mobile and fixed receivers in the United States and Canada. The Sirius XM broadcast network delivers signals to such receivers with audio broadcast information from two geographically-separated satellites and, in urban areas, an ancillary signal delivered by a terrestrial repeater. Service is available when any one of these three signals is available with sufficient field strength at the user's receiver. The hybrid satellite-terrestrial network improves service availability in urban environments, providing a signal in areas in which a mobile user's line of sight may be blocked to both satellites. The custom-designed Sirius XM receivers decode and combine two or more of the received signals to play the content to the user with no gaps in service. The satellite network provides no return channel from any satellite signal receiver.

Expansion of the terrestrial repeater network is constrained by several factors: regulatory requirements, cost, and technical limitations. Each repeater must be individually licensed by the appropriate regulatory agency, a process which imposes significant lead time and additional costs before the repeater can be constructed. The initial cost of the repeater equipment and then the recurring maintenance and lease costs add up quickly in a network of several hundred repeaters. Technical concerns such as interference from repeaters with overlapping coverage areas also limit the location of each repeater and the overall size of the network.

While the current mobile broadcast network architecture has proven to provide a highly robust service, the network is costly to maintain and provides limited ancillary signal coverage.

The systems and methods of this invention surmount these problems.

### SUMMARY OF THE INVENTION

The systems and methods of this invention use a combination of satellite, terrestrial repeater, and internet delivered signals, all with at least some common content, to implement a broadcasting system to mobile and fixed receivers and to provide a return channel for users in some areas, e.g., urban and suburban areas.

The internet delivered signal may supplement or replace signals from terrestrial repeaters in some areas, e.g., well-connected urban and suburban areas, and may improve service coverage and service offerings. Service coverage increases significantly. The SDARS service area is extended to any location with an internet connection and to any type of internet-connected device. Home and office service becomes feasible without a dedicated receiver or a satellite antenna. Mobile users in many areas can access the broadcast information in their cars, and on mass transit systems, including subways and tunnels that have cellular or WiMax coverage.

Bandwidth can be used efficiently by segmenting channel assignments between satellite/internet as appropriate. Content that has a wide range of interest such as music and national news, talk, and sports may be delivered by satellite, repeater, and Internet in order to reach the widest possible audience. Content of a more local nature, such as weather and traffic conditions, may be offered via internet with better granularity for specific locations rather than broadcasting such information across the entire satellite coverage area. Local-only news and sports, such as high school results, may be offered only in a modest-sized region of interest via internet. Satellites need not broadcast content of local interest to all areas, thus using satellite bandwidth more efficiently. Better allocation of satellite bandwidth may permit greater programming variety, including more niche content, such as non-English language talk and music.

The addition of a return channel via internet within service areas also increases the variety of service offerings available. Search, point of sale, and personalized features all become feasible with an internet return channel available to users.

Receivers which transparently switch between satellite, repeater, and internet reception increase the scope of services available to mobile users, and lead to more efficient use of bandwidth for the overall service. Such receivers may provide quality of service comparable to that of the existing SDARS network despite the variations in satellite signal strength, repeater availability, wireless network connectivity, and Internet data rates that some receivers encounter.

### BRIEF DESCRIPTION OF THE DRAWINGS

The systems and methods of this invention can better be understood by reference to the drawings, in which:

FIG. 1 shows Sirius XM Radio terrestrial repeater network locations in the United States as of March, 2012, which are limited to major urban markets;

FIG. 2 shows an SDARS broadcast system which includes a mobile terminal with a two way connection device to the internet providing an ancillary signal and a return channel; and

FIGS. 3 and 3A show generalized block diagrams of a mobile radio receiver and systems for delivering satellite and terrestrial repeater radio broadcast signals and wireless internet signals to the receiver of FIG. 2; this receiver can function in the broadcast system shown in FIG. 2.

### DETAILED DESCRIPTION OF THE DRAWINGS

The systems and methods of the invention improve upon the current satellite audio broadcast system for use with fixed and mobile receivers in the service area. The mobile receivers have antennas configured to view the sky where satellites would be visible and can also receive signals from terrestrial repeaters and connect to the internet to both receive and send signals.

Analysis input parameters for these systems and methods are: the definition of the geographical service area, and the quality and type(s) of service to be provided. The quality of service is defined as the percent of time service is unavailable due to satellite signal outage because of physical blockage, multipath or tree/foliage attenuation. When satellite signal outage arises from physical signal delivery blockage from buildings in urban environments, the current systems/methods deliver ancillary signals to maintain service availability.

Current implementations of the ancillary signal delivery operate over limited geographical coverage areas. The addition of internet-delivered ancillary signals expands the broadcast service areas to any area where any internet-capable device can connect to the internet. As a result, internet ancillary service improves service availability and expands service area.

Adding internet ancillary service to the fixed and mobile system receivers improves the type of services provided by enabling more efficient use of bandwidth and by providing two-way services. The amount and range of content broadcast via the satellite and repeater network can be expanded and bandwidth recouped by transferring local-interest content to internet delivery. An internet return channel enables users to ask for entertainment and data they want, delivering information to meet individual requests.

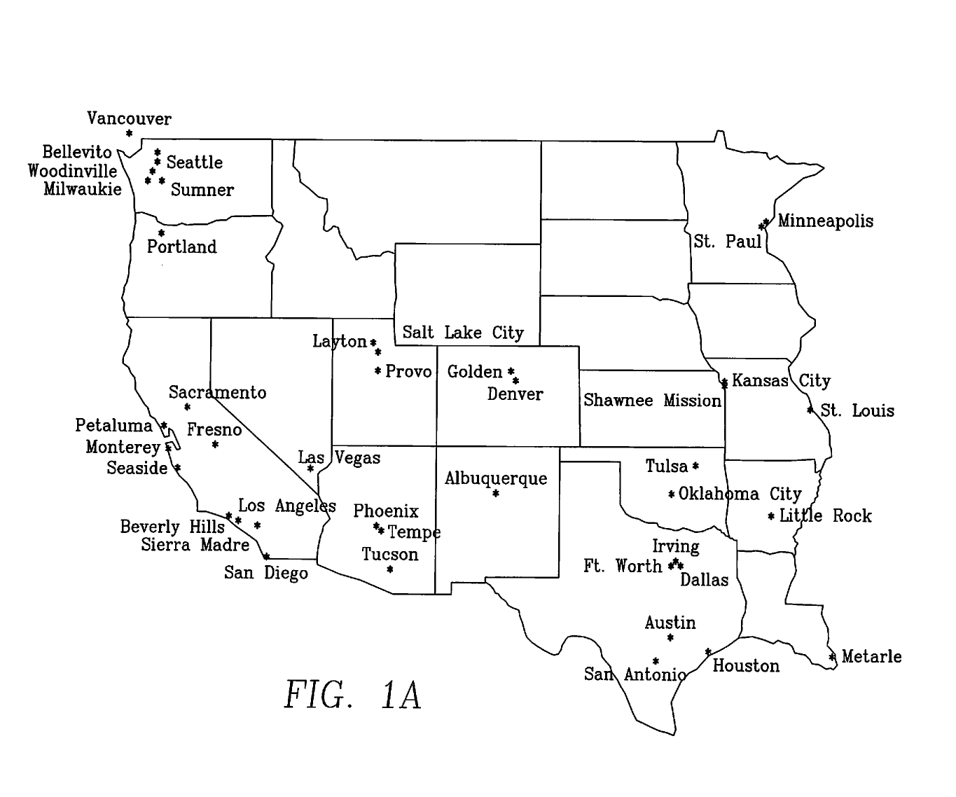

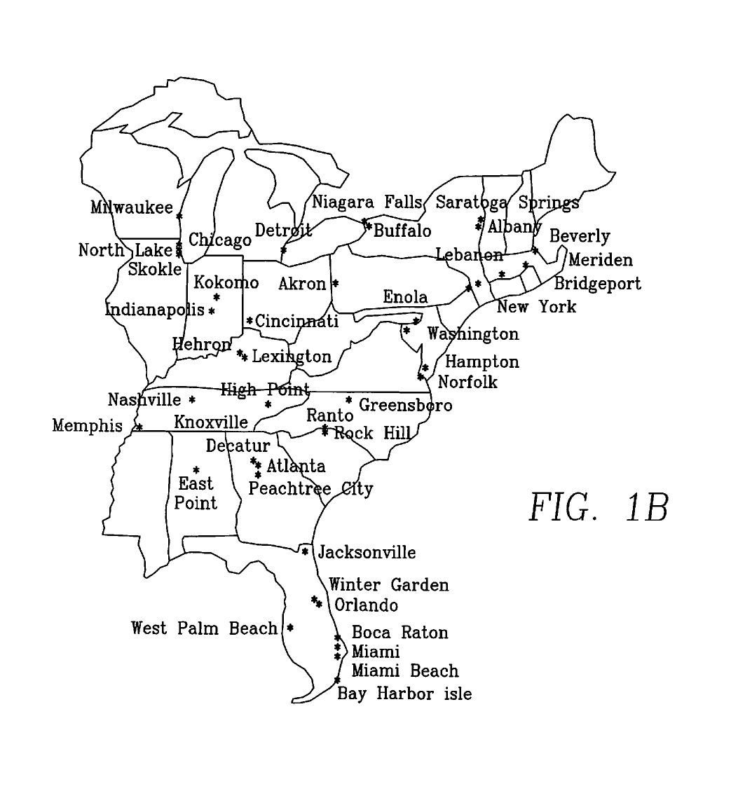

FIG. 1 shows the Sirius XM Radio terrestrial repeater locations in the United States as of March, 2012. As is apparent, terrestrial repeaters are located in urban locations where satellite signal reception may be physically blocked by tall buildings.

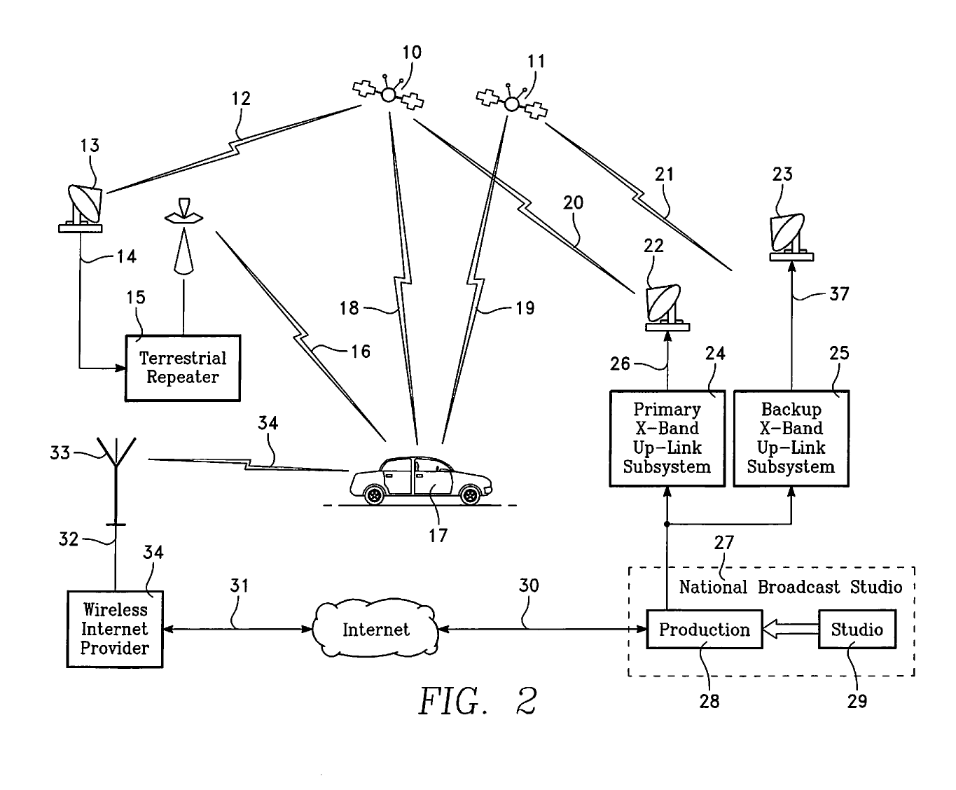

FIG. 2 shows an embodiment of the new systems and methods. Satellites 10 and 11 deliver substantially the same audio information, substantially concurrently, via downlinks 18 and 19, respectively, to mobile receiver 17, here, in an automobile. Satellite 10 also delivers substantially the same audio information, substantially concurrently, via path 12 to antenna 13 and path 14 to terrestrial repeater 15. From repeater 15, this information passes on path 16 to receiver 17. Information is delivered to satellites 10 and 11 from broadcast studio 27, which includes production and studio facilities 28 and 29, via up-link systems 24 and 25, paths 37 and 26, antennas 22 and 23, and up-link paths 20 and 21.

Studio 27 delivers substantially the same audio information, substantially concurrently, via path 30, internet connection 31, internet provider 34, path 32, tower 33, and path 34, to mobile receiver 17, and to all other receivers in the system that have internet accessibility. The receivers output one of these four signals, alone or supplemented by one or more of the other three signals, to assure uninterrupted service. The internet input also provides video and data information not available from the other three signal sources, and a return channel for a receiver to send a user message via the internet.

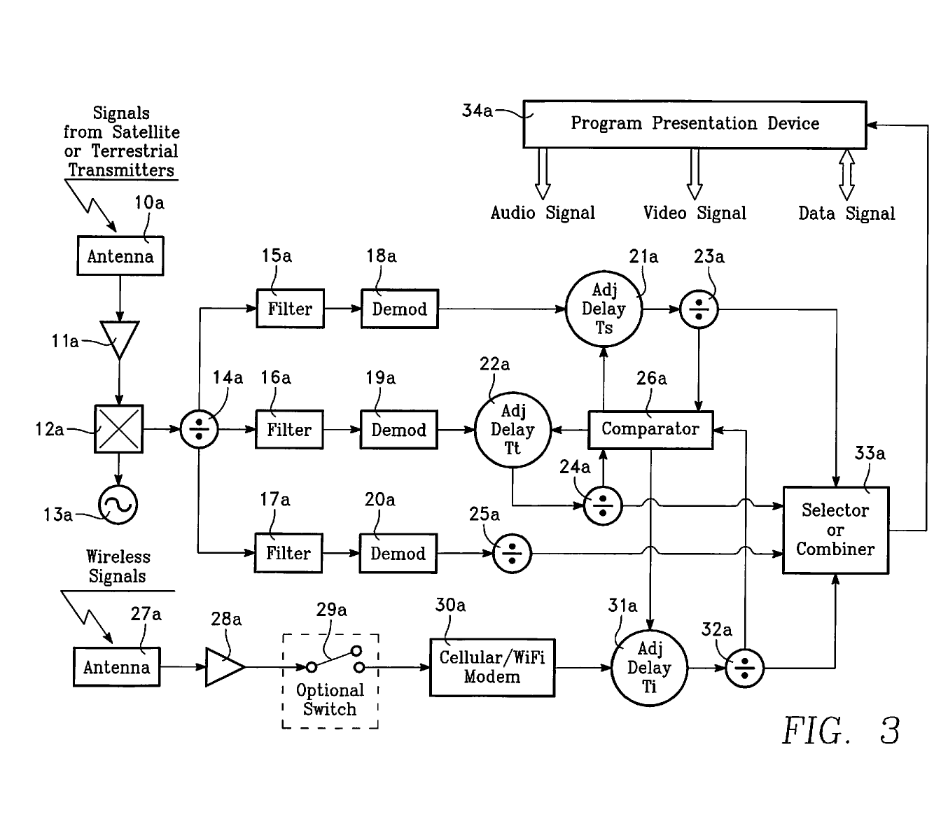

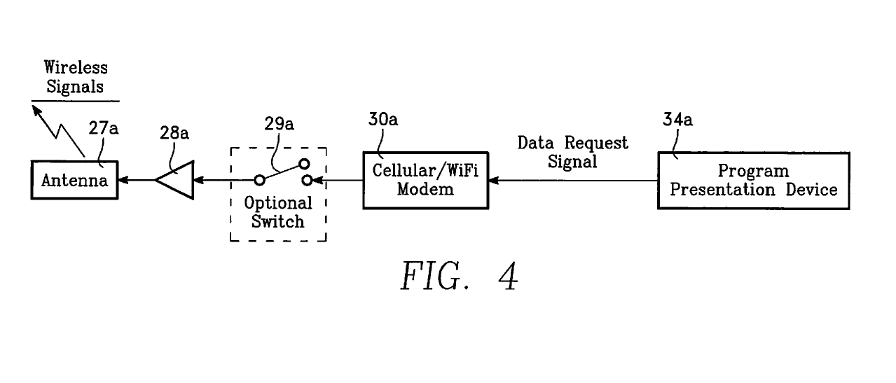

FIG. 3 shows &generalized block diagram of a multi-frequency mobile radio receiver configured for time and signal diversity operation. The configuration is compatible with the broadcast system described in FIG. 2. The program material sent to satellite 11 is delayed at the broadcast studio 27 by the desired satellite buffer time, Tₛ. The program material sent via terrestrial repeater 15 is delayed relative to the satellite 10 signal the desired terrestrial buffer time, Tₜ. The program material sent via the internet is buffered to account for packet losses and is delayed from the satellite 10 signal by time, Tᵢ. The mobile receiver contains an antenna 10 whose bandwidth and beamwidth is adequate to receive radio frequency signals transmitted by the SDARS satellites and terrestrial repeaters. The received signals are amplified in a preamplifier 11 and translated to a convenient frequency for demodulation by a downconverter 12 which is controlled by an oscillator 13. A divider 14 allows the signal to be processed on parallel paths. The downconverted transmissions are filtered (via filters 15, 16, 17) and demodulated (via demodulators 18, 19, 20). Dividers 23, 24, 25 allow the signals to be processed within a comparator 26 to correct for timing differences between each signal via adjustable delay circuits 21, 22. The receiver adjusts the timing of the demodulated signals by a time approximately equal to the delay in the original transmission (Tₛ or Tₜ, as appropriate) to re-synchronize the signals.

The mobile radio receiver also receives and transmits wireless terrestrial signals via an antenna 27 whose bandwidth and beamwidth is adequate to receive and transmit wireless radio frequency signals with cellular and WiFi repeaters. The received signal is amplified in a preamplifier 28 and, if the signal path is enabled by the user via the optional on/off switch 29, processed via a wireless modem 30. The receiver adjusts the timing of the signal by a time approximately equal to the desired amount of buffering to protect against loss of data packets in the wireless stream (Tᵢ) via adjustable delay circuit 31. The internet signal is then divided (via divider 32) so that one path goes through the same comparator 26 to synchronize it with the satellite and terrestrial repeater signals while the other path goes to selector/combiner 33.

All of the received, synchronized signals are then sent to the selector/combiner circuit 33. The selector circuit chooses the program material from the received signals based on availability, and in a continuous sequence, based on the time code. The combiner continuously sums the received signals that are above a predetermined threshold level. The output from the selector/combiner is the continuous program material with substantially no discontinuities, even when the mobile radio receiver is unable to receive all transmissions, up to a time limit determined by the maximum amount of signal delay allowed.

The output of the selector/combiner circuit feeds the mobile radio receiver program presentation device 34, which may contain devices such as an audio detector, amplifier, a user interface, and loudspeakers and/or a visual display and/or a data terminal such as a computer. The program presentation device may also contain memory to store content for later use and/or a software processor to allow content to be formatted and presented in user-friendly applications. A presentation device may be battery operated and/or allow connections to external power sources. Alternately, the selector/combiner output could be fed to an external presentation device allowing the user to select the preferred device and to change to new presentation devices.

FIG. 3A shows how the same terrestrial wireless receiver components are used to provide a return channel through users can request data via the internet. The user request is input to program presentation device 34 and formatted via cellular modem 33. If enabled by the user via the optional cellular path on/off switch 29, then the data request is sent through preamplifier 28 to be transmitted via antenna 27 to the terrestrial wireless network.

What is claimed is:

1. A system of providing satellite broadcast transmissions to fixed and mobile receivers in a defined geographical service area, said system including at least two satellites that broadcast substantially simultaneously, broadcast signals having substantially the same content, to a plurality of mobile receivers, said receivers outputting a substantially continuous, time-ordered signal derived from input to and storage in said receiver of one or more satellite radio broadcast signals, and one or more terrestrial repeater radio broadcast signals, said radio broadcast signals having frequencies in the range of about 1 to about 4 GHz, each of said radio broadcast signals having substantially the same program content, and one or more wireless internet signals having at least substantially the same program content as said radio broadcast signals, received by said receiver at different times and stored in said receiver, comprising, in said receiver, a system for storing at least one of said radio broadcast signals, at least one of said wireless internet signal, if available, or multiple signals, said storage system delaying output of the first-received signal at least for a time equal to the time differential between the same program element of other said stored radio broadcast signals and said stored wireless internet signals in said receiver, and a system for combining and outputting said substantially continuous, time-ordered signal including audio content, and, optionally, video content, data content, or both.

2. A mobile radio receiver for outputting a substantially continuous, time-ordered signal derived from input to and storage in said receiver of one or more satellite radio broadcast signals, and one or more terrestrial repeater radio broadcast signals, said radio broadcast signals having frequencies in the range of about 1 to about 4 GHz, each of said radio broadcast signals having substantially the same program content, and one or more wireless internet signals having at least substantially the same program content as said radio broadcast signals, received by said receiver at different times and stored in said receiver, comprising, in said receiver, a system for storing at least one of said radio broadcast signals, at least one of said wireless internet signal, if available, or multiple signals, said storage system delaying output of the first-received signal at least for a time equal to the time differential between the same program element of other said stored radio broadcast signals and said stored wireless internet signals in said receiver, and a system for combining and outputting said substantially continuous, time-ordered signal including audio content, and, optionally, video content, data content, or both.

3. The mobile radio receiver of claim 2 wherein the receiver delays said time-ordered signal output for at least about 0.5 seconds.

4. The mobile radio receiver of claim 2 wherein said storage system includes buffer storage and a delay synchronizer connected to said buffer storage.

5. The mobile radio receiver of claim 2 further comprising a system for combining said input radio broadcast signals and wireless Internet signals, or, alternatively, selecting portions of two or more of said input signals, to form said time-ordered output signal.

6. The mobile radio receiver of claim 2 further comprising a wireless Internet data signal transmitter for transmitting data requests via a wireless internet network.

7. The mobile receiver of claim 6 wherein said transmitter transmits said data requests for a sufficient time to substantially eliminate outages from a change in wireless network data connection speeds, missed data packets, or both.

8. The mobile receiver of claim 6 wherein said transmitter can output, from one or more mobile receivers, requests for content demand over the internet.
